(19) United States
(12) Patent Application Publication
(10) Pub. No.: US 2012/0269645 A1
(43) Pub. Date: Oct. 25, 2012

(54) WIND TURBINE COMPONENT HAVING AN EXPOSED SURFACE MADE OF A HYDROPHOBIC MATERIAL

(75) Inventors: Srikanth Narasimalu, Singapore (SG); Premkumar Jeromerajan, Singapore (SG)

(73) Assignee: VESTAS WIND SYSTEMS A/S, Aarhus N (DK)

(21) Appl. No.: 13/391,018

(22) PCT Filed: Aug. 19, 2010
(86) PCT No.: PCT/EP10/62095

§ 371 Date: Jul. 6, 2012

(30) Foreign Application Priority Data
Nov. 2, 2009 (DK) PA 2009 70186

(51) Int. Cl. F03D 11/00; B05D 3/06; B05D 5/00; B05D 1/36

(52) U.S. Cl. 416/241 R; 427/202; 427/558; 427/559

(57) ABSTRACT

The invention provides a wind turbine component having an exposed surface made of a hydrophobic material and having a surface texture providing a Water Contact Angle (CA) of at least 150. Due to the combination between a CA over 150 and the hydrophobic material, the component becomes less vulnerable to ice formation etc. The invention further provides a method of preventing ice formation, a method of reducing noise and a blade for reducing noise from a wind turbine.

The invention relates to a wind turbine component having a surface of a hydrophobic material.

### BACKGROUND OF THE INVENTION

Wind turbines are exposed to various impacts and they are typically designed to resist the worst imaginable conditions.

Formation of dirt, moist, or ice on the nacelle and tower of a wind turbine may increase the weight and shape of these components and necessitate an increased strength of the carrying structure. In a similar manner, such formation on the blades and rotor may change the aerodynamic properties of the wind turbine and thus decrease the efficiency of the turbine.

Weather conditions leading to specific weight or aerodynamic changes are typically at least partly unpredictable and, naturally, the change in weight and surface shape is unwanted.

Until now, various non-stick surface coatings have been proposed for prevention of adherence of water and dirt to the exterior surfaces. None of these, presently known, surfaces have proven reliable and effective in practise.

EP 1 141 543 discloses a rotor blade formed with a liquid-repellent layer comprising an uneven surface and a varnish with Teflon characteristics.

### DESCRIPTION OF THE INVENTION

It is an object of the invention to provide a wind turbine component which is less affected by moist and dirt over time, and which reduces or prevents formation of ice.

According to a first aspect, the invention provides a wind turbine component having a surface made of a hydrophobic material and having a surface texture, wherein the surface provides a Water Contact Angle (CA) of at least 150.

Due to the high water contact angle in combination with the hydrophobic material, it has been found that formation of ice can be reduced or completely prevented, and formation of dirt and moist on the surface may be limited effectively. In particular, ice adhesion strength below 50 Kpa may be observed.

The term “hydrophobic” material herein covers any kind of material lacking affinity to water and tending to repel and not absorb water. The term also covers materials which tend not to dissolve in, mix with, or be wetted by water.

The hydrophobic material could include fluroPU and PU, and it may in addition include Poly-tetra-flour-ethylene (PTFE), or materials having characteristics similar to that of Teflon.

The hydrophobic material may be applied to the component e.g. by spraying, and particularly by airless spraying. The particles could be mixed into the hydrophobic material by mechanical stirring prior to the application or after the application, e.g. by a spray distribution process, where the particles are distributed onto the painted surface by use of air pressure.

The hydrophobic material could be cured by us of UV or sun light radiation, and it may be advantageous to ensure adhesion strength of the coating above 4 MPa.

The surface texture could be formed by granular particles projecting from a surface of a hydrophobic material, in particular from particles extending about 100-500 microns above the surface of the hydrophobic material. In comparison, the surface of the hydrophobic material, when disregarding the granular particles extending upwards there from, may have a surface roughness of about 1-10 microns.

The granular particles may comprise various plastic materials. They may e.g. be made from PTFE and/or Silica.

The particles may have a size between 100 and 1000 nm and they may have a spherical shape.

The particles may form inter-molecular bonding with the hydrophobic material. In one embodiment, each particle has a tail end being encapsulated in the hydrophilic material, the tail end forming active groups. The active groups may comprise OH or CO groups which facilitate the inter-molecular bonding.

The component may form housing for the drive train and generator, i.e. a so called nacelle for the wind turbine. The component may form part of the tower, or form the entire tower to prevent icing of the tower, or the component may form part of the rotor or rotor blades. In particular with regards to the blades, the invention may protect against dimensional changes due to icing and thus reduced efficiency due to the changed aerodynamic shape of the blades. Specific areas of the blades may be more important than other areas of the blades. In this regards, it may be an advantage at least to provide the hydrophobic material with texture and CA above 150 on the trailing edge of the blade, or on the trailing edge and on the side surfaces towards the leading edge, e.g. to cover 25-50 percent of the total outer surface of the blades.

In a second aspect, the invention provides a method of preventing icing on an exposed surface of a wind turbine component, the method comprising applying a layer of a hydrophobic paint to the exposed surface, and arranging granular particles in the paint such that the particles project from the layer of paint.

The layer may be applied in a thickness of 100-150 micron over the entire outer surface of the wind turbine or over selected areas, e.g. selected areas of the blades, e.g. by spraying, e.g. by airless spraying. Prior to the application, the surface may be pre-treated to ensure adhesion strength of at least 4 Mpa.

Granular particles could be mixed with the paint before the paint is applied e.g. by mechanical stirring, or they could be arranged in the not-yet cured layer of paint. Finally, the paint could be cured by UV radiation.

In a third aspect, the invention provides a blade for reducing noise in operation of a wind turbine, the blade having an exposed surface made of a hydrophobic material and having a surface texture providing a Water Contact Angle (CA) of at least 150.

In a fourth aspect, the invention provides a method of reducing noise in a wind turbine, the method comprising applying a layer of a hydrophobic paint to the exposed surface, and arranging granular particles in the paint such that the particles project from the layer of paint.

The third and fourth aspect may include any of the features and steps described already with respect to the first and second aspects of the invention.

### DETAILED DESCRIPTION

Further scope of applicability of the present invention will become apparent from the following detailed description and specific examples. However, it should be understood that the detailed description and specific examples, while indicating embodiments of the invention, are given by way of illustration only, since various changes and modifications within the spirit and scope of the invention will become apparent to those skilled in the art from this detailed description.

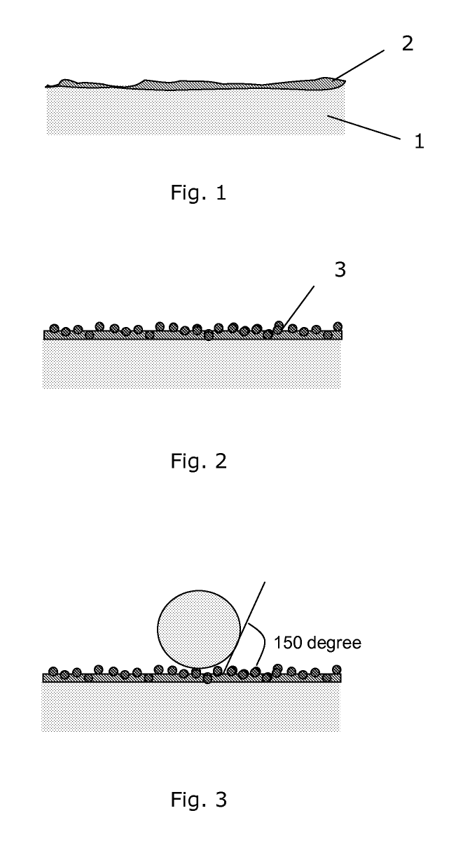

FIGS. 1-6 illustrate schematically a coating sequence for providing a component according to the invention, and

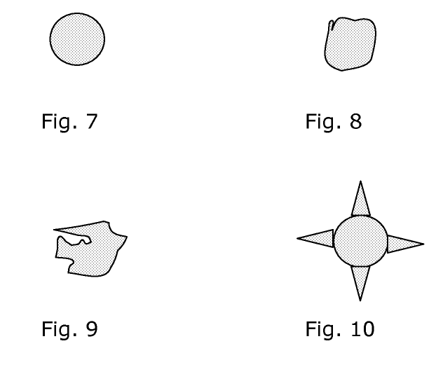

FIGS. 7-10 illustrate preferred shapes of the granular particles.

As shown in FIG. 1, the wind turbine component 1 is coated with a layer 2 of a hydrophobic material.

FIG. 2 illustrates that granular particles 3 have been arranged in the layer 2, such that the particles extend upwardly from the hydrophobic material.

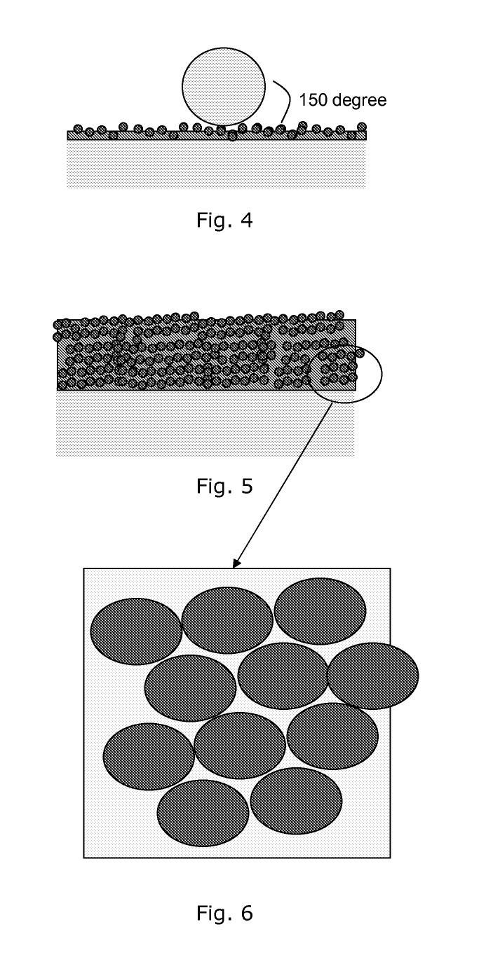

FIGS. 3 and 4 illustrate how the shape and size of the particles 3 provides the CA of at least 150 degrees.

FIGS. 5 and 6 illustrate the arrangement of the granular particles side-by-side on the exposed surface. FIG. 6 is an enlarged view of a section of FIG. 5.

FIGS. 7-10 illustrate cross sections through granular particles with different shapes.

1. A wind turbine component having an exposed surface made of a hydrophobic material and having a surface texture providing a Water Contact Angle (CA) of at least 150.

2. The component according to claim 1, wherein the hydrophobic material comprises a material selected from the group consisting of fluroPU and PU.

3. The component according to claim 1, wherein the surface texture is formed by granular particles projecting from a surface of a hydrophobic material.

4. The component according to claim 3, wherein the granular particles extend about 100-500 microns above the surface of the hydrophobic material.

5. The component according to claim 3, wherein the granular particles comprises a material selected from the group consisting of PTFE and Silica.

6. The component according to claim 3, wherein the particles have a size between 100 and 1000 nm.

7. The component according to claim 3, wherein the particles have a spherical shape.

8. The component according to claim 3, wherein the particles form inter-molecular bonding with the hydrophobic material.

9. The component according to claim 3, wherein each particle has a tail end being encapsulated in the hydrophilic material, the tail end forming active groups.

10. The component according to claim 9, wherein the active groups comprises OH or CO groups.

11. The component according to claim 1, forming a blade for the wind turbine.

12. A method of providing anti-icing properties on an exposed surface of a wind turbine component, the method comprising applying a layer of a hydrophobic paint to the exposed surface and arranging granular particles in the paint such that the particles project from the layer of paint.

13. The method according to claim 12, wherein the layer is applied in a thickness of 100-150 micron.

14. The method according to claim 12, wherein the layer is applied by airless spraying.

15. The method according to claim 12, wherein the layer is cured by UV radiation or by sun light radiation.

16. The method according to claim 12, wherein the granular particles are applied in the paint by mechanical stirring prior to the application of the paint on the surface.

17. The method according to claim 12, wherein the granular particles are applied after a layer of paint has been applied.

18. The method according to claim 17, wherein the granular particles are applied by spraying the particles into the not yet cured layer of paint.

19. A blade for reducing noise in operation of a wind turbine, the blade having an exposed surface made of a hydrophobic material and having a surface texture providing a Water Contact Angle (CA) of at least 150.

20. A method of reducing noise in a wind turbine, the method comprising applying a layer of a hydrophobic paint to the exposed surface, and arranging granular particles in the paint such that the particles project from the layer of paint.
